(19) United States
(12) Patent Application Publication
(10) Pub. No.: US 2026/0259920 A1
(43) Pub. Date: Sep. 3, 2026

(54) SIMILARITY BASED CONTENT MODERATION SYSTEM

(71) Applicant: INTUIT INC., Mountain View, CA (US)

(72) Inventors: Eilon SHEETRIT, Tel-Aviv (IL); Yael HOCHMA, Tel Aviv (IL); Sheer DANGOOR, Ramat-Gan (IL); Ido Joseph FARHI, Azor (IL)

(21) Appl. No.: 19/067,703

(22) Filed: Feb. 28, 2025

(51) Int. Cl. G06F 16/353

(52) U.S. Cl. CPC G06F 16/353

(57) ABSTRACT

A method for similarity based content moderation includes generating an embedding of input text. The method includes retrieving, based on the embedding of the input text, a plurality of embeddings of text examples from a data store, wherein each respective text example of the text examples is assigned a label indicating whether the respective text example violates a policy. The method includes calculating a plurality of similarity scores based on the embedding of the input text and the plurality of embeddings of text examples. The method includes filtering, by comparing the plurality of similarity scores to a threshold similarity score, the text examples to generate a filtered set of text examples and generating a label for the input text using the filtered set of text examples.

### INTRODUCTION

Aspects of the present disclosure relate to content moderation systems and, more particularly, to a similarity based content moderation system for predicting a label for input text based on a similarity score between an embedding of the input text and embeddings of labeled text examples.

### BACKGROUND

Content moderation generally involves detecting content that violates one or more policies. Given the rise of generative artificial intelligence models and the integration of generative artificial intelligence models in different domains, content moderation has many different use cases. For example, web services (e.g., social medial platforms, forums, and blogs) that allow for user engagement (e.g., by posting content) utilize content moderation to detect content, either human generated content or machine generated, that violates policies established by providers of such web services.

Given the many different use cases for content moderation, custom models and training procedures are generally needed. For example, lightweight classifier models (e.g., as a stacked ensemble) or language processing machine learning models (e.g., a large language model) may be trained (e.g., fine-tuned) to predict whether content (e.g., human-generated or machine-generated) violates certain policies. Lightweight classifier models typically generate predictions faster compared to language processing machine learning models, but predictions generated by lightweight classifier models are typically less accurate compared to predictions generated by language processing machine learning models.

Accordingly, there is a need in the art for improved techniques for implementing content moderation.

### BRIEF SUMMARY

In one aspect, a method for performing similarity based content moderation is provided. The method generally includes: generating, using an embedding model, an embedding of input text; retrieving, based on the embedding of the input text, a plurality of embeddings of text examples from a data store, wherein each respective text example of the text examples is assigned a label indicating whether the respective text example violates a policy; calculating a plurality of similarity scores based on the embedding of the input text and the plurality of embeddings of text examples, each respective similarity score indicating how similar the input text is to a respective text example of the text examples; filtering, by comparing the plurality of similarity scores to a threshold similarity score, the text examples to generate a filtered set of text examples; and generating a label for the input text using the filtered set of text examples, wherein the label for the input text corresponds to the label assigned to one or more text examples included in the filtered set of text examples.

In another aspect, a method for operating a multi-tier content moderation system is provided. The method includes: providing an embedding of an input text to a first tier of the multi-tier content moderation system and a second tier of the multi-tier content moderation system, the first tier including a similarity based content moderation system, the second tier including an ensemble of classifier models trained to classify the input text; determining, at the first tier of the multi-tier content moderation system, whether a similarity score between the embedding of the input text and each of a plurality of embeddings of labeled text examples satisfies a threshold similarity score; and performing, based on the determining, an action with respect to the ensemble of classifier models.

In yet another aspect, a similarity based content moderation system is provided. The similarity based content moderation system includes a memory including computer executable instructions and a processor configured to execute the computer executable instructions and cause the similarity based content moderation system to: generate, using an embedding model, an embedding of input text; retrieve, based on the embedding of the input text, a plurality of embeddings of text examples from a data store, wherein each respective text example of the text examples is assigned a label indicating whether the respective text example violates a policy; calculate a plurality of similarity scores based on the embedding of the input text and the plurality of embeddings of the text examples, each respective similarity score indicating how similar the input text is to a respective text example of the text examples; filter, by comparing the plurality of similarity scores to a threshold similarity score, the text examples to generate a filtered set of the text examples; and generate a label for the input text using the filtered set of the text examples, wherein the label for the input text corresponds to the label assigned to one or more text examples included in the filtered set of the text examples.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a computing environment for similarity based content moderation, according to certain embodiments.

FIG. 2 depicts a similarity based content moderation system, according to certain embodiments.

FIG. 3 depicts a multi-tier content moderation system, according to certain embodiments.

FIG. 4 depicts a flow diagram of a method for performing similarity based content moderation, according to certain embodiments.

FIG. 5 depicts a flow diagram of a multi-tiered approach for moderating content, according to certain embodiments.

FIGS. 6A and 6B depicts an example processing systems for similarity based content moderation, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for similarity based content moderation.

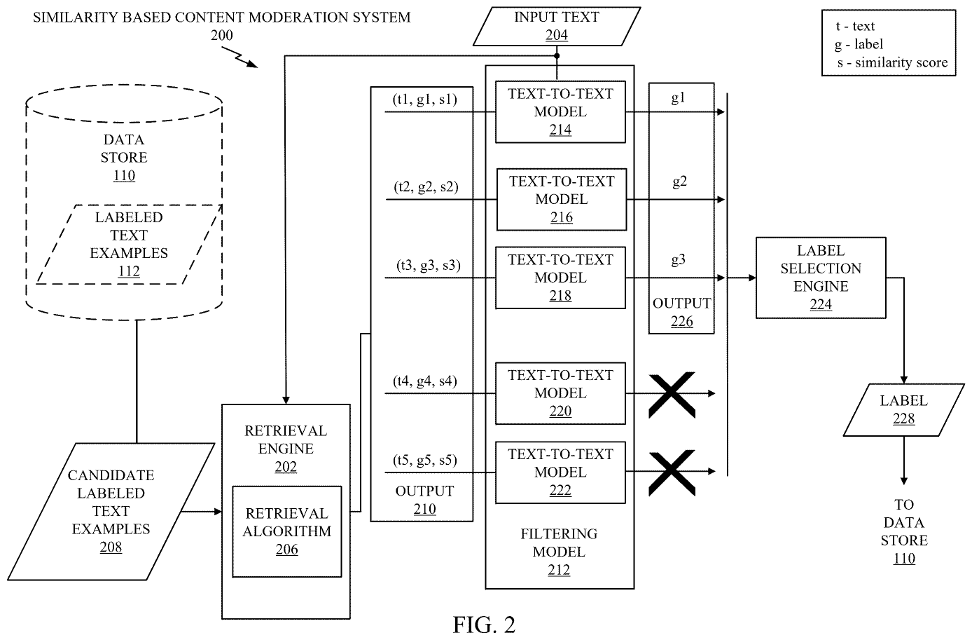

Example aspects of the present disclosure are directed to a similarity based content moderation system. As will be discussed in more detail with reference to FIG. 2, the similarity based content moderation system may annotate (e.g., label) input text using a data store of previously labeled text examples. The labels may generally indicate whether the text examples violate a policy associated with moderating content on software applications (e.g., social media platforms). For example, the label may be a first binary number (e.g., 1) to indicate compliance with the policy or a second binary number (e.g., 0) to indicate non-compliance with the policy. To generate a label for the input text, the similarity based content moderation system may compare an embedding of the input text to embeddings of the labeled text examples to determine which labeled text examples are most similar to (e.g., have the same intent as) the input text. The similarity based content moderation system may then annotate the input text based on the label of those text examples that are determined to be most similar to the input text. The similarity based content moderation according to the present disclosure is generally faster at predicting a label for input text compared to classifier models and/or language processing machine learning models that are used in conventional content moderation systems. For instance, the similarity based content moderation system according to the present disclosure may generally provide real-time predictions of labels for input text.

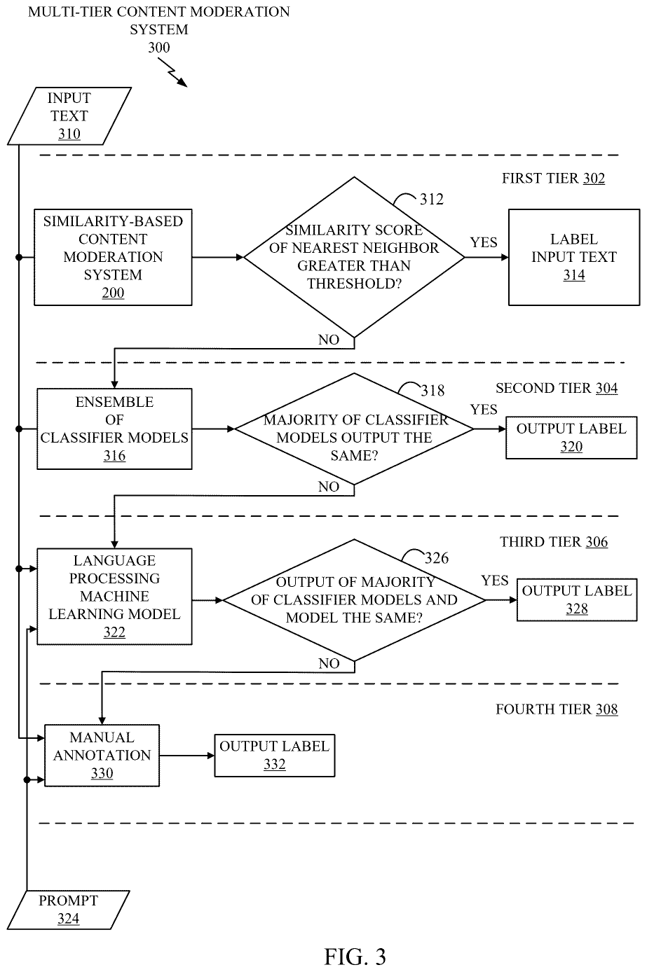

As will be discussed below in more detail with reference to FIG. 3, the similarity-based content moderation system may be used in conjunction with classifier models and language processing machine learning models to provide a multi-tier content moderation system. More specifically, the similarity based content moderation system may be the first tier of the multi-tier content moderation, the classifier models (e.g., more computationally expensive and time-consuming compared to the similarity based content moderation system) may be the second tier of the multi-tier content moderation system, and the language processing machine learning model (e.g., more computationally expensive and time-consuming compared to the classifier modes) may be the third tier of the multi-tier content moderation system. In operation, input text may first be provided to the similarity based content moderation system. If the similarity based content moderation system cannot annotate the input text (that is, the similarity score for the closest labeled text example in the data store is below a threshold similarity score), the classifier models may be used to annotate the input text. If the classifier models cannot annotate the input text (that is, there is no majority agreement amongst the classifier models regarding the predicted classification for the input text), then the input text may be provided to the language processing machine learning model. In this manner, by implementing a funnel approach (e.g., starting with the similarity based content moderation system and proceeding to classifier models and, subsequently, a language processing machine learning model if needed) for annotating input text, the multi-tier content moderation system allows input text to be moderated (e.g., labeled as being in compliance with a policy or violation of the policy) in a more efficient and accurate manner compared to conventional content moderation systems that involve using classifier models or language processing machine learning models.

Example aspects of the present disclosure provide numerous technical effects and benefits. For instance, by comparing an embedding of input text to embeddings of previously labeled text examples to determine which of the text examples is most similar (e.g., has the same intent) to the input text and annotating the input text with the label of the most similar text example, the similarity based content moderation system allows content moderation to be performed in real-time and is less computationally intensive compared to conventional content moderation systems. For example, the similarity based content moderation system does not require training like the classifier models and language processing machine learning models used in conventional content moderation systems, and requires fewer computational resources to run than such models. Additionally, by integrating the similarity based content moderation system, an ensemble of classifier models, and a language processing machine learning model as a multi-tier content moderation system according to the present disclosure, the multi-tier content moderation system provides a funnel-like framework (e.g., starting with similarity based content moderation system and proceeding to classifier models and language processing machine learning model if needed) that allows input text to be annotated in a more efficient manner (e.g., faster and more accurately) compared to conventional content moderation systems that only include one tier (e.g., classifier models or a language processing machine learning model).

### Example Computing Environment for Similarity Based Content Moderation

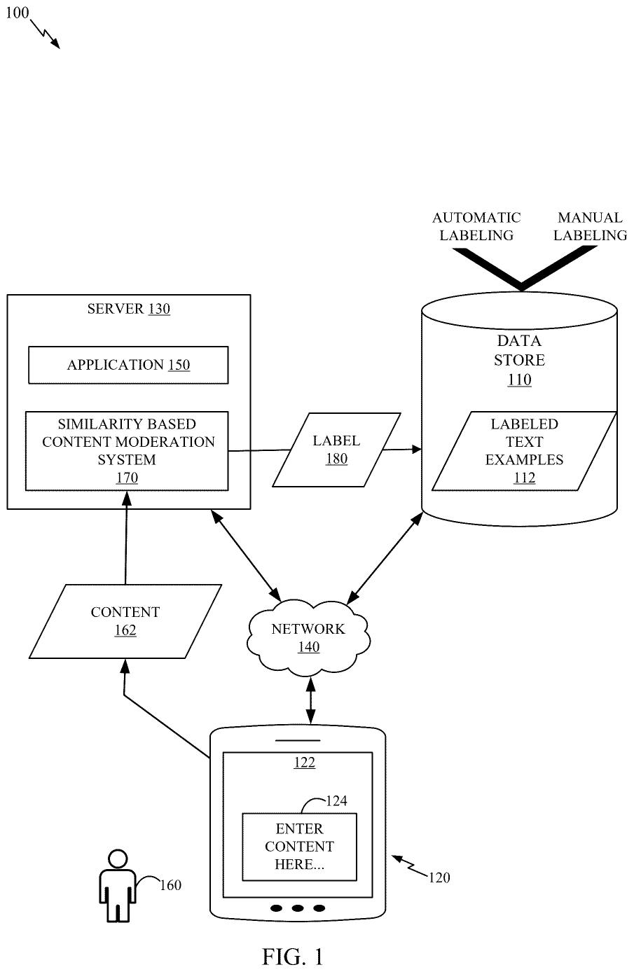

FIG. 1 depicts a computing environment 100 for content moderation according to some embodiments of the present disclosure.

The computing environment 100 includes a data store 110, a client device 120, and a server 130 connected over a network 140. The network 140 may be representative of any type of connection over which data may be transmitted, such as a wide area network (WAN), a local area network (LAN), and/or the like.

The data store 110 may be configured to store a plurality of labeled text examples 112 (e.g., strings of text) that are automatically labeled or manually labeled (e.g., by a human). In some embodiments, the data store 110 may be a vector database and the plurality of labeled text examples 112 may be stored in the vector database as a plurality of vector embeddings to facilitate fast retrieval. An embedding generally refers to a vector representation of each respective labeled text example as a vector in n-dimensional space such that labeled text examples having a similar meaning and/or intent are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. In one example, an embedding model used to generate embeddings described herein comprises an E5 (EmbEddings from bidirectional Encoder rEpresentations) text embedding model. In another example, an embedding model used to generate embeddings comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embeddings are possible.

In some embodiments, the label for each of the labeled text examples 112 stored in the data store 110 may be a binary number to indicate whether the respective text example violates a policy. For example, text examples that violate the policy may be annotated with a first binary number (e.g., 1), and text examples that comply with the policy may be annotated with a second binary number (e.g., 0). In some embodiments, the label for each respective text example may be a multiclass label. For instance, each respective text example included in the plurality of labeled text examples 112 may correspond to one of a plurality of different topics, and the label for each respective text example may indicate one of the plurality of different topics.

The server 130 generally includes a computing device, such as a server computer. The server 130 includes a software application 150, which generally represents a computing application that users may interact with over the network 140 via a user interface 122 displayed on the client device 120. For example, the user interface 122 may include a text box 124 in which a user 160 may input content 162.

In some aspects, the software application 150 may be a social media platform and the content 162 generated by the user 160 may include content for publication on the social media platform. For example, the content 162 generated by the user 160 may include text that the user wants to post (e.g., publish) on a page associated with a unique profile the user 160 created when joining the social media platform. As another example, the content 162 generated by the user 160 may include a comment to content posted by another user on the social media platform.

The server 130 may include a similarity based content moderation system 170. As will be discussed in more detail with reference to FIG. 2, the similarity based content moderation system 170 may be configured to automatically generate a label 180 for the content 162 based on a similarity score between the content 162 and one or more of the plurality of labeled text examples 112 stored in the data store 110. The label 180 may indicate whether the content 162 violates a policy, such as a policy established by an entity that created the software application 150.

### Example Similarity Based Content Moderation System

FIG. 2 depicts a similarity based content moderation system 200 according to some embodiments of the present disclosure. The similarity based content moderation system 200 may be implemented as the similarity based content moderation system 170 in the computing environment 100 discussed above with reference to FIG. 1.

The similarity based content moderation system 200 has a lower latency for predictions (e.g., labeling input text) compared to conventional content moderation systems that, as discussed above, may use one or more classifier models or a language processing machine learning model. In this manner, the similarity based content moderation system 200 may be improved compared to conventional content moderation systems.

The similarity based content moderation system 200 includes a retrieval engine 202. The retrieval engine 202 may be configured to receive input text 204 (e.g., string of text) and generate an embedding of the input text 204. The retrieval engine 202 may be further configured to implement a retrieval algorithm 206 to retrieve candidate labeled text examples 208 from the plurality of labeled text examples 112 stored on the data store 110. For example, in some embodiments, the retrieval algorithm 206 may be a fast approximation K nearest neighbor (AKNN) and the candidate labeled text examples 208 may include labeled text examples whose embeddings are close (e.g., cosine similarity or other similarity measure above a threshold) to the embedding of the input text 204. In some embodiments, the candidate labeled text examples 208 may include multiple labeled text examples, such as five labeled text examples as illustrated in FIG. 2.

The retrieval engine 202 may be configured to generate an output 210 that includes each of the multiple text examples (e.g., by denoted by t1, t2, t3, t4, t5), the corresponding labels (e.g., denoted by g1, g2, g3, g4, g5), and a similarity score (e.g., denoted by s1, s2, s3, s4, s5) calculated by the retrieval engine 202 and indicative of the similarity between the embedding of the input text 204 and the embedding of the respective text example.

The similarity based content moderation system 200 may include a filtering model 212 configured to filter (e.g., remove) one or more labeled text examples included in the candidate labeled text examples 208. For instance, the filtering model 212 may be configured to filter out labeled text examples in the candidate labeled text examples 208 that are not similar enough (e.g., similarity score below a threshold similarity score) to the input text 204.

In some embodiments, the filtering model 212 may include multiple instances of text-to-text models to accommodate the multiple labeled text examples that are included in the candidate labeled text examples 208. For instance, in some embodiments, the filtering model 212 may include a first instance 214 of the text-to-text model, a second instance 216 of the text-to-text model, a third instance 218 of the text-to-text model, a fourth instance 220 of the text-to-text model, and a fifth instance 222 of the text-to-text model. In other embodiments, the filtering model 212 may include more or fewer instances of the text-to-text model.

Each instance of the text-to-text model may be configured to receive a respective text example (e.g., t1, t2, t3, t4, t5), a corresponding label (e.g., g1, g2, g3, g4, g5), and a calculated similarity score (e.g., s1, s2, s3, s4, s5). For instance, the first instance 214 of the text-to-text model may be configured to receive a first text example t1, a label g1 for the first text example t1, and a calculated similarity score s1 based on the embedding of the input text 204 and the embedding of the first text example t1. The second instance 216 of the text-to-text model may be configured to receive a second text example t2, a label g2 for the second text example t2, and a calculated similarity score s2 based on the embedding of the input text 204 and the embedding of the second text example t2. The third instance 218 of the text-to-text model may be configured to receive a third text example t3, a label g3 for the third text example t3, and a calculated similarity score s3 based on the embedding of the input text 204 and the embedding of the third text example t3. The fourth instance 220 of the text-to-text model may be configured to receive a fourth text example t4, a label g4 for the fourth text example t4, and a calculated similarity score s4 based on the embedding of the input text 204 and the embedding of the fourth text example t4. The fifth instance 222 of the text-to-text model may be configured to receive a fifth text example t5, a label g5 for the fifth text example t5, and a calculated similarity score based on the embedding of the input text 204 and the embedding of the fifth text example t5.

In some embodiments, each instance of the text-to-text model may be configured to determine whether the calculated similarity score satisfies (e.g., is equal to or greater than) a threshold similarity score. Furthermore, in some embodiments, the threshold similarity score may be tailored according to a particular use case of the similarity based content moderation system 200. In alternative embodiments, the threshold similarity score may be the same for any given use case of the similarity based content moderation system 200.

As illustrated, the first instance 214 of the text-to-text model may determine the calculated similarity score s1 satisfies the threshold similarity score and may output the label g1 for the first text example t1. The second instance 216 of the text-to-text model may determine the calculated similarity score s2 satisfies the threshold similarity score and may output the label g2 for the second text example t2. The third instance 218 of the text-to-text model may determine the calculated similarity score s3 satisfies the threshold similarity score and may output the label g3 for the third text example t3. The fourth instance 220 of the text-to-text model may determine the calculated similarity score s4 does not satisfy the threshold similarity score and may forego outputting the label g4 for the fourth text example t4. The fifth instance 222 of the text-to-text model may determine the calculated similarity score s5 does not satisfy the threshold similarity score and may forego outputting the label g5 for the fifth text example t5.

The similarity based content moderation system 200 may include a label selection engine 224 configured to receive an output of the filtering model 212. For example, as illustrated in FIG. 2, the output 226 of the filtering model 212 may include the output (e.g., label g1) of the first instance 214 of the text-to-text model, the output (e.g., label g2) of the second instance 216 of the text-to-text model, and the output (e.g., label g3) of the third instance 218 of the text-to-text model. The label selection engine 224 may be configured to output a label 228 for the input text 204. In some embodiments, the label selection engine 224 may be configured to determine the label 228 based on the output 226 of the filtering model 212. For example, as illustrated in FIG. 2, the output 226 of the filtering model 212 may include the labels (e.g., g1, g2, g3) output by the first instance 214 of the text-to-text model, the second instance 216 of the text-to-text model, and the third instance 218 of the text-to-text model, respectively.

In some embodiments, the label selection engine 224 may compare the labels (e.g., g1, g2, g3) included in the output 226 of the filtering model 212 to determine whether a majority of the labels are the same and may automatically assign the label for the majority of the labels (e.g., g1, g2, g3) as the label 228 for the input text 204. If the label selection engine 224 determines the majority of the labels are not the same as one another, the label selection engine 224 may assign the label (e.g., g1, g2, or g3) of the text example (e.g., t1, t2, or t3) that is most similar to the input text 204 as the label 228 for the input text 204. More specifically, the label selection engine 224 may select the label of the text example with the highest calculated similarity score (e.g., s1, s2, s3). In this manner, the label selection engine 224 may select the most similar label even though there is no majority agreement amongst the different labels (e.g., g1, g2, g3) included in the output 226 of the filtering model 212.

In some embodiments, the similarity based content moderation system 200 may be configured to store the label 228 for the input text 204 on the data store 110. In this manner, the labeled text examples 112 included in the data store 110 may be updated to include the input text 204 and the label 228 for the input text 204.

### Example Multi-Tier Content Moderation System

FIG. 3 depicts a multi-tier content moderation system 300 according to some embodiments of the present disclosure.

The multi-tier content moderation system 300 may include a first tier 302, a second tier 304, a third tier 306, and a fourth tier 308. The first tier 302, the second tier 304, and the third tier 306 may involve automatically determining a label for input text 310. The fourth tier 308 may involve manually determining a label for the input text 310. As will be discussed in more detail, the multi-tier content moderation system 300 may operate sequentially, beginning with the first tier 302 and proceeding to successive tiers (e.g., second tier 304, third tier 306, and fourth tier 308) of the multi-tier content moderation system 300 if needed. Furthermore, since the latency associated with predictions (that is, labeling input text 310) increases with each successive tier of the multi-tier content moderation system 300, the funnel approach (e.g., starting with the first tier 302 and proceeding to subsequent tiers if needed) allows input text 310 to be labeled more efficiently (e.g., in real-time) and more accurately. An embedding of input text 310 may be generated using an embedding model, such as an E5 text embedding model or other suitable type of embedding model.

The first tier 302 may include the similarity based content moderation system 200 discussed above with reference to FIG. 2. The similarity based content moderation system 200 may be configured to determine a similarity score between an embedding of the input text 310 and embeddings of labeled text examples (e.g., labeled text examples 112 of FIG. 2) stored in a data store (e.g., data store 110 of FIG. 2).

At 312, the similarity based content moderation system 200 may be configured to determine whether the highest similarity score between the embedding of the input text 310 and a first text example of the plurality of labeled text examples satisfies (e.g., is greater than) a threshold similarity score. If the similarity based content moderation system 200 determines the highest similarity score satisfies the threshold similarity score, then the similarity based content moderation system 200 may, at 314, use the label for the first text example of the plurality of labeled text examples as the label for the input text 310. Otherwise, the second tier 304 of the multi-tier content moderation system 300 may be used to determine the label for the input text 310.

In some embodiments, the second tier 304 of the multi-tier content moderation system 300 may include an ensemble of classifier models 316. Each of the classifier models 316 may be fine-tuned to predict one of a plurality of different classes as a predicted label for the input text 310. In some embodiments, the different classes may be weighted differently.

At 318, the output (e.g., predicted class) of each of the classifier models 316 is evaluated to determine whether a label can be assigned to the input text 310 at the second tier 304 of the multi-tier content moderation system 300.

In some embodiments, the label for the input text 310 may be determined at the second tier 304 of the multi-tier content moderation system 300 based on whether a majority of the classifier models 316 classify the input text 310 in the same class. If the majority of the classifier models 316 predict the same class for the input text 310, then the class predicted by the majority of the classifier models 316 may be used as the label for the input text 310. Otherwise, the third tier 306 of the multi-tier content moderation system 300 may be used to determine the label for the input text 310.

In some embodiments, the label for the input text 310 may be determined at the second tier 304 of the multi-tier content moderation system 300 based a weighted sum of the predictions generated by the classifier models 316. For instance, a normalized score may be determined using the following formula:

$$\frac{w 1 + w 2 + w 3 + … wn}{total number of classifier models}$$

where the sum of the assigned weight, w, for the class prediction generated by each of the classifier models 316 is divided by the total number of classifier models 316 to generate a total normalized score. Furthermore, if the total normalized score is above a threshold score, then the highest scoring class prediction is assigned as the label for the input text. Otherwise, the third tier 306 of the multi-tier content moderation system 300 may be used to determine the label for the input text 310.

It is noted that in some embodiments, first tier 302 and second tier 304 may be performed simultaneously. For example, input text 310 may be fed simultaneously to similarity based content moderation system 200 and ensemble of classifier models 316. In such an embodiment, if the similarity score of the nearest neighbor is greater than the threshold at 312, then second tier 304 may be abandoned (e.g., the output of ensemble of classifier models 316 may not be checked or, if one or more classifier models in the ensemble of classifier models 316 are still running then such model(s) may be stopped) and, at 314, the label for the first text example of the plurality of labeled text examples may be used as the label for the input text 310. Otherwise, predictions generated by the ensemble of classifier models 316 at second tier 304 may be checked (e.g., at 318, as described above). Generally, third tier 306 may not be reached unless both first tier 302 and second tier 304 fail to result in assigning a label at 314 or 320.

In some embodiments, the third tier 306 of the multi-tier content moderation system 300 may include a language processing machine learning model 322, such as a large language model (LLM), trained (e.g., fine-tuned) to predict a label for input text, such as input text 310.

In some embodiments, the language processing machine learning model 322 may include a transformer-based model. Examples of transformer-based models may include, without limitation, a bidirectional encoder representation from transformers (BERT) or a generative pre-trained transformer (GPT). By using the language processing machine learning model 322, a label may be predicted for the input text 310.

In some embodiments, training of the language processing machine learning model 322 involves a supervised learning process that involves providing training inputs to the language processing machine learning model 322. The language processing machine learning model 322 can process the training inputs and determine outputs based on the training inputs. The outputs are compared to known labels associated with the training inputs (e.g., labels manually applied to training data by experts or otherwise known to be associated with the training inputs) to determine the accuracy of the language processing machine learning model 322, and parameters of the language processing machine learning model 322 are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the language processing machine learning model 322 based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for the model, such as based on validation data and test data, as is known in the art.

In some embodiments, “training” may refer to instruction training, instruction fine-tuning, or prompt-based training in which feedback data is provided as context data or as a few-shot learning example with a prompt 324 to the language processing machine learning model 322 to instruct the language processing machine learning model 322 to generate a response (e.g., predicted label for input text 310) to the prompt in a manner that is informed by the feedback data.

In some embodiments, the prompt 324 may include contextual examples that are selected via retrieval-augmented generation (RAG) from the same collection of data (e.g., labeled text examples) that are initially provided to the similarity based content moderation system 200 deployed in the first tier 302 of the multi-tier content moderation system 300. The RAG may assist the language processing machine learning model 322 in understanding the task at hand (e.g., determining a label for input text 310) to improve the accuracy of results determined by the language processing machine learning model 322.

At 326, the output (e.g., predicted label) of the language processing machine learning model 322 and the output of the classifier models 314 is compared. For instance, if the language processing machine learning model 322 and a majority of the classifier models 314 labeled the input text 310 the same (that is, predicted the same classification for the input text 310), then the input text 310 may be labeled accordingly at 328. Otherwise, the fourth tier 308 of the multi-tier content moderation system 300 may be used to determine the label for the input text 310.

The fourth tier 308 of the multi-tier content moderation system 300 may involve manual annotation 330. For instance, manual annotation 330 may include one or more humans (e.g., trained professionals) determining a label 332 for the input text 310. In some embodiments, the human(s) may be provided the prompt 324 that is provided to the language processing machine learning model 322. In this manner, the prompt 324 may assist the human(s) in understanding the task and may provide contextual examples to improve the accuracy of the label 332 the human(s) ultimately determine for the input text 310.

It should be appreciated that manual annotation 330 is generally more time-consuming compared to the automated annotation approaches included in each of the first tier 302, second tier 304, and third tier 306 of the multi-tier content moderation system 300. Thus, manual annotation 330 is typically only used for input text that is difficult to label automatically at any of the first tier 302, second tier 304, and third tier 306 of the multi-tier content moderation system 300.

In some embodiments, the label 332 for the input text 310 may be provided as feedback data to the similarity based content moderation system 200, the ensemble of classifier models 314, or both. For instance, the data store (e.g., data store 110 in FIG. 2) from which the similarity based content moderation system retrieves labeled text examples may be updated to include the label 332 and the input text 310. In this manner, the multi-tier content moderation system 300 may label the input text 310 the next time the input text 310 is provided to the multi-tier content moderation system 300 for labeling. For instance, the similarity based content moderation system 200, which generally predicts labels for input text faster than the classifier models 314 and the language processing machine learning model 322, may be used to label the input text 310 the next time and therefore may avoid using subsequent tiers (e.g., second tier 304, third tier 306, fourth tier 308) of the multi-tier content moderation system 300 that are more computationally expensive and time-consuming.

### Example Operations for Similarity Based Content Moderation

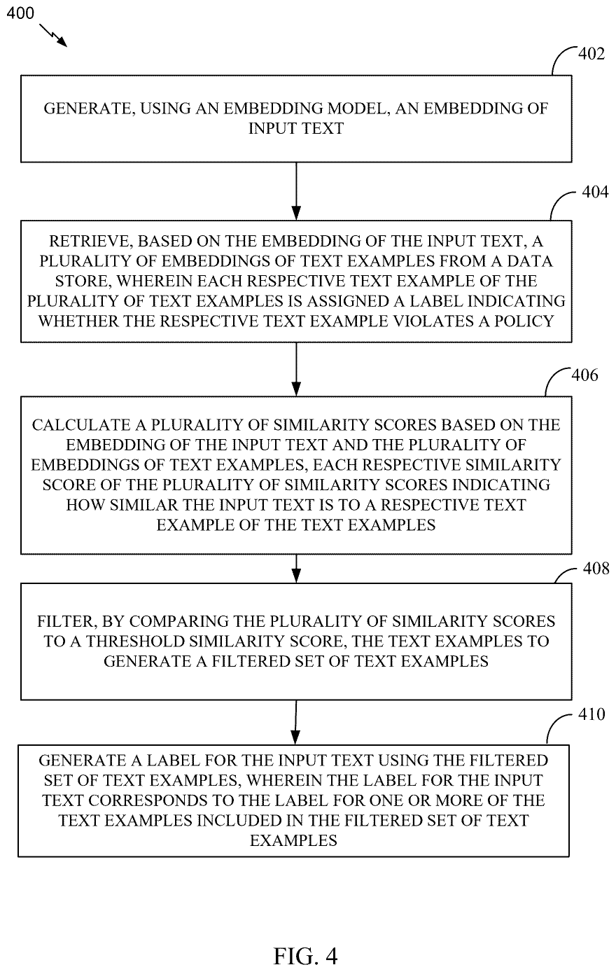

FIG. 4 depicts example operations 400 for similarity based content moderation according to some embodiments of the present disclosure. For example, operations 400 may be performed using the similarity based content moderation system 200 of FIG. 2, and/or one or more other components and/or devices.

Operation 402 includes generating an embedding of input text. For instance, the input text may be provided as an input to an embedding model (e.g., E5 text embedding model or other suitable type of embedding model) configured to convert the input text into an embedding. In some embodiments, the similarity based content moderation system may include the embedding model. In other embodiments, the embedding model may be standalone (that is, not part of the similarity based content moderation system).

Operation 404 includes retrieving a plurality of embeddings of labeled text examples from a data store. In some embodiments, the retrieving may be performed by the retrieval engine 202 of the similarity based content moderation system 200. For instance, the retrieval engine 202 may be configured to execute a retrieval algorithm (e.g., fast approximate k nearest neighbor) to obtain the plurality of embeddings of labeled text examples.

Operation 406 includes calculating a plurality of similarity scores based on the embedding of the input text and the plurality of embeddings of text examples. For instance, the similarity based content moderation system 200, such as the retrieval engine 202 thereof, may be configured to calculate the plurality of similarity scores.

Operation 408 includes filtering, by comparing the plurality of similarity scores to a threshold similarity score, the plurality text examples to generate a filtered set of text examples. For instance, the similarity based content moderations system 200 may include a filtering model, such as filtering model 212, configured to compare the plurality of similarity scores to the threshold similarity score to filter (e.g., remove) text examples having a similarity score that does not satisfy (e.g., is less than) the threshold similarity score.

Operation 410 includes generating a label for the input text using the filtered set of text examples. For instance, the similarity based content moderation system, such as the label selection engine 224 thereof, may be configured to generate the label for the input text. For instance, in some embodiments, the label selection engine may be configured to compare the label for each text example included in the filtered set of text examples to determine if the same label is used for a majority of the text examples and, if so, may assign the same label to the input text. Furthermore, in some embodiments, the same label may not be used for a majority of the text examples included in the filtered set of text examples. In such embodiments, the label selection engine may be configured to select the label of the text example in the filtered set of text examples that is most similar (that is, has the highest similarity score) to the input text.

### Example Operations for Multi-Tier Content Moderation System

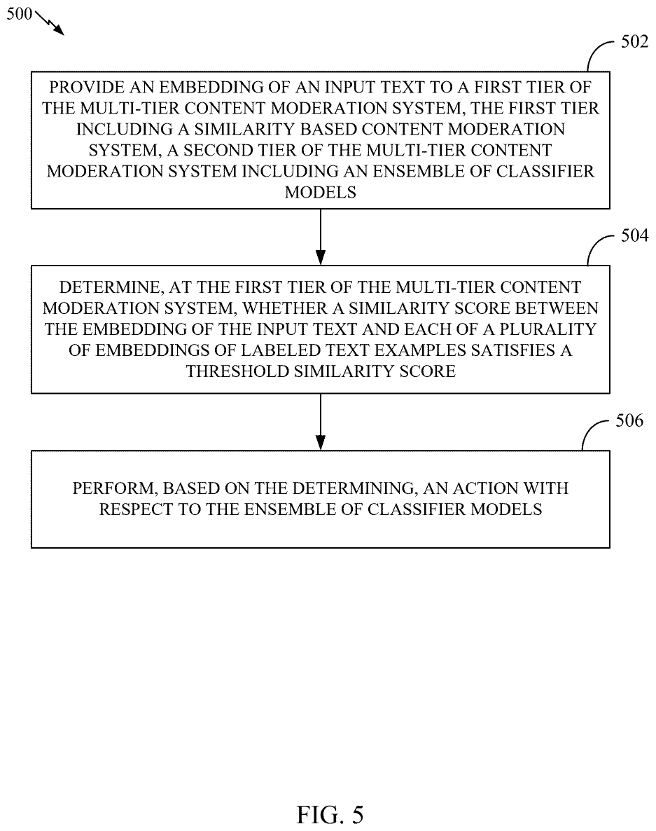

FIG. 5 depicts example operations 500 for a multi-tier content moderation system according to some embodiments of the present disclosure. For example, operations 500 may be performed using the multi-tier content moderation system 300 of FIG. 3, and/or one or more other components and/or devices.

Operation 502 includes providing an embedding of an input text to a first tier of the multi-tier content moderation system and a second tier of the multi-tier content moderation system. The first tier of the multi-tier content moderation system may include a similarity based content moderation system, such as the similarity based content moderation system 200 of FIG. 2. The second tier of the multi-tier content moderation system may include an ensemble of classifier models trained to predict a label for input text, such as the ensemble of classifier models 316 of FIG. 3.

Operation 504 includes determining, at the first tier of the multi-tier content moderation system, whether a similarity score between the embedding of the input text and each of a plurality of embeddings of labeled text examples satisfies a threshold similarity score.

Operation 506 includes performing, based on operation 504, an action with respect to the ensemble of classifier models. For instance, if the similarity score between the embedding of the input text and one or more of the embeddings of labeled text examples satisfies the threshold similarity score, the operation includes stopping operation of the ensemble of classifier models with respect to predicting a label for the input text. Alternatively, if the similarity score between the embedding of the input text and each of the embeddings of the labeled text examples does not satisfy the threshold similarity score, the action comprises comparing the label predicted for the input text by each of the classifier models to determine whether a majority of the classifier models predicted a same label for the input text.

### Example Computing System

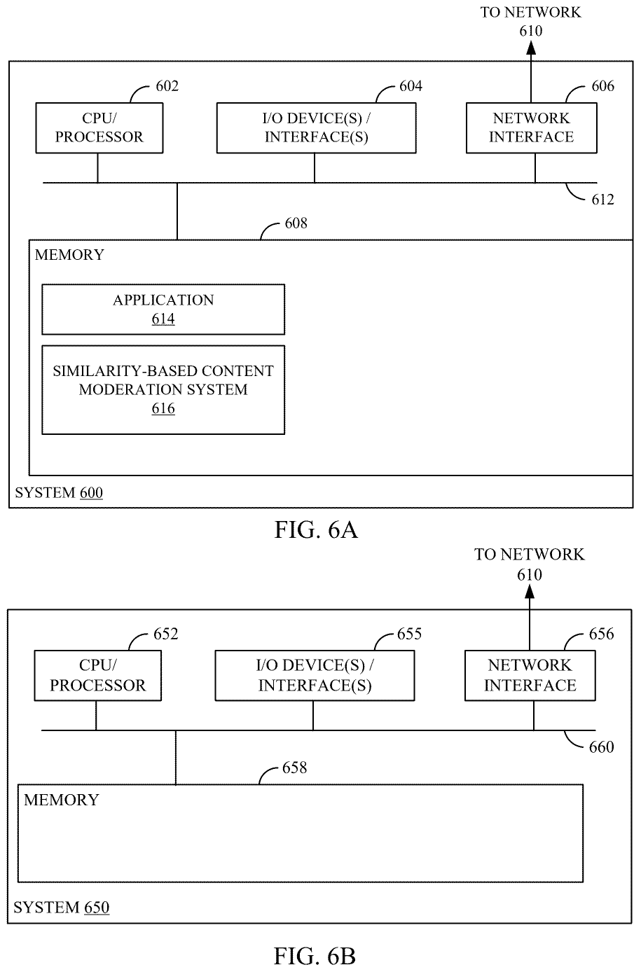

FIG. 6A illustrates an example computing system 600 with which the similarity based content moderation system 200 of FIG. 2 may be implemented. For example, the computing system 600 may be representative of the server 130 of FIG. 1.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610. It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes an application 614 and a similarity based content moderation system 616, which may be representative of the software application 150 of FIG. 1 as well as the similarity based content moderation system 200 of FIG. 2.

FIG. 6B illustrates an example computing system 650 with which embodiments of the disclosure related to similarity based content moderation system may be implemented. For example, the computing system 650 may be representative of the client device 120 of FIG. 1.

The computing system 650 includes a central processing unit (CPU) 652, one or more I/O device interfaces 654 that may allow for the connection of various I/O devices 654 (e.g., keyboards, displays, mouse devices, pen input, etc.) to the computing system 650, a network interface 656, a memory 658, and an interconnect 660. It is contemplated that one or more components of the computing system 650 may be located remotely and accessed via the network 610. It is further contemplated that one or more components of the computing system 650 may include physical components or virtualized components.

The CPU 652 may retrieve and execute programming instructions stored in the memory 658. Similarly, the CPU 652 may retrieve and store application data residing in the memory 658. The interconnect 660 transmits programming instructions and application data, among the CPU 652, the I/O device interface 654, the network interface 656, the memory 658. The CPU 652 is included to be representative of a single CPU, multiple CPUs, a single CPU having multiple processing cores, and other arrangements.

Additionally, the memory 658 is included to be representative of a random access memory or the like. In some embodiments, the memory 658 may include a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for performing similarity based content moderation, comprising:
generating, using an embedding model, an embedding of input text;
retrieving, based on the embedding of the input text, a plurality of embeddings of text examples from a data store, wherein each respective text example of the text examples is assigned a label indicating whether the respective text example violates a policy;
calculating a plurality of similarity scores based on the embedding of the input text and the plurality of embeddings of the text examples, each respective similarity score indicating how similar the input text is to a respective text example of the text examples;
filtering, by comparing the plurality of similarity scores to a threshold similarity score, the text examples to generate a filtered set of the text examples; and
generating a label for the input text using the filtered set of the text examples, wherein the label for the input text corresponds to the label assigned to one or more text examples included in the filtered set of the text examples.

2. The method of claim 1, wherein the retrieving comprises performing an approximate k nearest neighbors (AKNN) search of the data store to obtain the plurality of embeddings of the text examples.

3. The method of claim 1, wherein the generating of the label comprises:
comparing the label assigned to each of the text examples included in the filtered set of the text examples;
determining, based on the comparing, a majority of the text examples included in the filtered set of the text examples have a same label; and
assigning the same label to the input text.

4. The method of claim 1, wherein the generating of the label comprises:
comparing the label assigned to each of the text examples included in the filtered set of the text examples;
determining, based on the comparing, a majority of the text examples included in the filtered set of the text examples do not have a same label;
based on determining the majority of the text examples do not have the same label, selecting a first similarity score of the similarity scores, wherein the first similarity score is higher than every other similarity score included in the similarity scores and indicates a similarity between the input text and a first text example of the text examples; and
assigning the label for the first text example as the label for the input text.

5. The method of claim 1, further comprising:
providing the input text and the label for the input text to the data store.

6. The method of claim 5, wherein the providing comprises:
generating an embedding of the input text and the label for the input text; and
storing the embedding of the input text and the label for the input text on the data store.

7. The method of claim 1, wherein the label assigned to each respective text example of the text examples comprises:
a first label indicating the respective text example does not violate the policy; or
a second label indicating the respective text example does violate the policy.

8. The method of claim 7, wherein:
the first label comprises a first binary number; and
the second label comprises a second binary number.

9. A method for operating a multi-tier content moderation system, comprising:
providing an embedding of an input text to a first tier of the multi-tier content moderation system and a second tier of the multi-tier content moderation system, the first tier including a similarity based content moderation system, the second tier including an ensemble of classifier models trained to classify the input text;
determining, at the first tier of the multi-tier content moderation system, whether a similarity score between the embedding of the input text and each of a plurality of embeddings of labeled text examples satisfies a threshold similarity score; and
performing, based on the determining, an action with respect to the ensemble of classifier models.

10. The method of claim 9, wherein:
the determining comprises determining the similarity score between the embedding of the input text and one or more embeddings of the labeled text examples satisfies the threshold similarity score; and
the performing comprises stopping operation of one or more classifier models with respect to predicting a label for the input text.

11. The method of claim 9, wherein:
the determining comprises determining the similarity score between the embedding of the input text and one or more embeddings of the labeled text examples satisfies the threshold similarity score; and
the performing comprises comparing the label each of the classifier models predicted for the input text.

12. The method of claim 11, wherein the comparing comprises:
determining whether a majority of the classifier models predicted a same label for the input text; and
the method further comprises performing, based on determining whether the majority of the classifier models predicted the same label for the input text, an action with respect to a language processing machine learning model included in a third tier of the multi-tier content moderation system.

13. The method of claim 12, wherein:
the determining whether a majority of the classifier models predicted the same label for the input text comprises determining the majority of the classifier models predicted the same label for the input text; and
performing the action with respect to the language processing machine learning model comprises stopping operation of the language processing machine learning model with respect to processing the input text to predict a label for the input text.

14. The method of claim 13, wherein
the determining whether a majority of the classifier models predicted the same label for the input text comprises determining the majority of the classifier models did not predict the same label for the input text; and
performing the action with respect to the language processing machine learning model comprises comparing a predicted label for the input text by the language processing machine learning model with the label predicted by each of the classifier models.

15. A similarity based content moderation system, comprising:
a memory including computer executable instructions; and
a processor configured to execute the computer executable instructions and cause the similarity based content moderation system to:
generate, using an embedding model, an embedding of input text;
retrieve, based on the embedding of the input text, a plurality of embeddings of text examples from a data store, wherein each respective text example of the text examples is assigned a label indicating whether the respective text example violates a policy;
calculate a plurality of similarity scores based on the embedding of the input text and the plurality of embeddings of the text examples, each respective similarity score indicating how similar the input text is to a respective text example of the text examples;
filter, by comparing the plurality of similarity scores to a threshold similarity score, the text examples to generate a filtered set of the text examples; and
generate a label for the input text using the filtered set of the text examples, wherein the label for the input text corresponds to the label assigned to one or more text examples included in the filtered set of the text examples.

16. The similarity based content moderation system of claim 15, wherein to retrieve the plurality of embeddings of the text examples from the data store, the processor is configured to perform an approximate k nearest neighbors (AKNN) search of the data store.

17. The similarity based content moderation system of claim 15, wherein to generate the label for the input text, the processor is configured to:
compare the label assigned to each of the text examples included in the filtered set of the text examples;
determine, based on the comparing, a majority of the text examples included in the filtered set of the text examples have a same label; and
assign the same label to the input text.

18. The similarity based content moderation system of claim 15, wherein to generate the label, the processor is configured to:
compare the label assigned to each of the text examples included in the filtered set of the text examples;
determine, based on the comparing, a majority of the text examples included in the filtered set of the text examples do not have a same label;
based on determining the majority of the text examples do not have the same label, select a first similarity score of the similarity scores, wherein the first similarity score is higher than every other similarity score included in the similarity scores and indicates a similarity between the input text and a first text example of the text examples; and
assign the label for the first text example as the label for the input text.

19. The similarity based content moderation system of claim 15, wherein the processor is further configured to:
provide the input text and the label for the input text to the data store.

20. The similarity based content moderation system of claim 19, wherein to provide the input text and the label to the data store, the processor is configured to:
generate an embedding of the input text and the label for the input text; and
store the embedding of the input text and the label for the input text on the data store.
